(19) United States
(12) Patent Application Publication
(10) Pub. No.: US 2020/0034899 A1
(43) Pub. Date: Jan. 30, 2020

(54) RESOURCE EXCHANGE VERIFICATION PROCESSING SYSTEM

(71) Applicant: BANK OF AMERICA CORPORATION, Charlotte, NC (US)

(72) Inventors: Joseph Benjamin Castinado, North Glenn, CO (US); Charles Russell Kendall, Snoqualmie, WA (US)

(21) Appl. No.: 16/045,227

(22) Filed: Jul. 25, 2018

(51) Int. Cl. G06Q 30/06; G06Q 30/00; G06Q 10/08; G06Q 10/02

(52) U.S. Cl. CPC G06Q 30/0609; G06Q 30/0613; G06Q 10/02; G06Q 10/087; G06Q 10/0835; G06Q 30/018

(57) ABSTRACT

Embodiments of the invention are directed to systems, methods, and computer program products for resource exchange verification. The system integrates with third party exchange sites and third party resource distribution networks to control processing and transferring of products digitally. In this way, the system verify that the seller owns the products via conformation communications with a product vendor, creating a proof of ownership network. Smart contract networks are generated allowing escrow of the product and not allow resources to be released until product verification. Furthermore, using information from the third party exchange site and the digital resource distribution network, the system identifies the user and tailors the experience associated with the product to the new product owner.

### BACKGROUND

The development of digital third party exchange sites, individuals are buying and selling products digitally. With advances in technology, misappropriation or misguidance may be easier. As such, a need exists for a digital resource exchange verification process.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Currently fraudsters use digital third party exchange sites to indicate that they may have products, services, or tickets for concerts, sporting events, or the like for sale via the digital third party exchange site. The fraudster may request resource payment for the products or services via a digital resource distribution network. Once the resources are transferred via the digital resource distribution network from the intended buyer to the seller, the seller disappears. As such, the intended buyer may provide a seller with resources and not provide the tickets or products as promised.

Embodiments of the invention are directed to systems, methods, and computer program products for resource exchange verification processing. The system integrates with third party exchange sites that allow users to exchange tickets or other products. Furthermore, the system integrates with seller systems and third party systems (such as product or ticket vendors) to verify that the seller owns the tickets or products, the system does this via identification that the seller purchased the products or tickets from a product vendor. In this way, the system creates a proof of ownership network. The system then generates a smart contract network with three parties, the proof of ownership network, the seller, and the buyer. The smart contract does not allow resources to be released from the buyers account until the smart contract has confirmation from the third party product vendor that the seller actually owns the product/tickets. The system, via the smart contract, then extracts the products/tickets from the seller and transfers the funds to the seller. The system using smart contracts may move the asset without introducing an ability for misappropriation, creating an authentication escrow network. This provides the buyer with a ticket and the system knows who the buyer is. Furthermore, using this information, the system could tailor the experience to that particular buyer as potential value adds (such as welcome gifts, drinks, food, or the like tailored to the particular buyer). In some embodiments, the invention may instigate the triggering of a hold of resources at the digital resource distribution network.

Embodiments of the invention relate to systems, methods, and computer program products for resource exchange verification processing, the invention comprising: interconnecting with a digital resource distribution network and a digital third party exchange site via generating a communication linkage; identifying a user initiation of an exchange via the digital third party exchange site; communicating with a product vendor for a product of the exchange, wherein the product vendor is an original distributor of the product of the exchange; generating a smart contract within a communicably linked proof of ownership network upon indication from the product vendor the user possesses the product of the exchange; placing the product of the exchange into an authentication escrow network and trigger distribution of resources via a digital resource distribution network; and upon distribution of resources, triggering release of the product of the exchange.

In some embodiments, the invention further comprises identifying the user that is a new recipient of the product of the exchange and tailor an experience around an event associated with the exchange to the user including added products associated with the product of the exchange.

In some embodiments, an authentication escrow network is an escrow that holds the product of the exchange such that a seller of the product of the exchange does not have possession of the product of the exchange upon buyer distribution of resources via the digital resource distribution network. In some embodiments, the escrow network may also hold pending offers, so that users may see other offers the seller has for the product. The escrow network may hold or otherwise prevent the seller from using the product. The payment for the product may not be associated with the escrow network, as such allowing the buyer to use any payment means for completing the transaction.

In some embodiments, communicating with an original product vendor for a product of the exchange further comprises receiving indication from the product vendor confirming or denying user possession of the product of the exchange.

In some embodiments, the user is a buyer or seller of the product on the digital third party exchange site, wherein the user is enrolled in the resource exchange verification processing prior to initiation of an exchange. In some embodiments, the user is a buyer purchasing the product using the digital resource distribution network to transfer resources to a seller for the product of the exchange. In some embodiments, the user is a seller selling the product using the digital third party exchange site to transfer the product of the exchange to a buyer for resources.

In some embodiments, the exchange via initiated via the digital third party exchange site is an exchange for the product, wherein the product is a ticket to one or more events.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 illustrates a resource exchange verification processing system environment, in accordance with embodiments of the present invention;

FIG. 2 illustrates the third party systems communicably linked within the resource exchange verification processing system, in accordance with embodiments of the present invention;

FIG. 3 illustrates a high level flowchart of the resource exchange verification process, in accordance with embodiments of the present invention;

FIG. 4 illustrates a process for resource exchange verification and follow on experience tailoring, in accordance with embodiments of the present invention; and

FIG. 5 illustrates generating communicable linkages and network for smart contract deployment within the resource exchange verification process, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “transaction” refers to any communication between a user and another user or entity to transfer a product in exchange for resources. A “product” may be a good, service, or ticket to an event, such as a concert, play, movie, sporting event, or the like.

As used herein, the term “resource” may be used to refer to currency or other items exchanged for a product or service. While “a resource distribution” may refer to any paper or digital signal that may transfer or exchange resources, such as funds or currency, across individuals or entities. Resource distribution may include checks, certified checks, automated clearing house, contract, person-to-person payments, credit card payments, debit card payments, transfers of cash, or the like. A “digital third party exchange site” may be an online platform for buyers and sellers to post products for sale or to purchase products. A “product vendor” may be one or more vendors or entities associated with the initial distribution of a product.

As used herein a digital resource distribution network may be a network for transferring resources via a person-to-person (P2P) payment application in coordination with a digital wallet application on the user's mobile device. Here, for example, the system may send the payment to a credit card associated with the recipient. Consequently, the system may present the functionality of the P2P payment application and/or the digital wallet application within the interface of the enhanced resource sharing management application to facilitate completion of the payment transfer. In addition, the system may integrate payment sharing functionality into the interface to enable the user to share or spilt the payment with multiple auxiliary users.

In some embodiments, the digital resource distribution network may provide a new payment vehicle to the user, for example, a credit card to the digital wallet of the user, in near real time to facilitate the payment transaction. For example, the system may provide a new payment vehicle suitable for the geographic region that the user is travelling to, a vehicle that provides certain incentives/rebates and the like. In some embodiments, the system provides foreign exchange services to facilitate overseas payments.

Moreover, the digital resource distribution network may analyze user information, e.g., user financial information and determine that the user may utilize existing gift cards, travel benefits, other accounts or incentives, to complete at least a portion of the payment for the dwelling reservation, and provide specific interfaces/overlays to facilitate the user of benefits, gift cards and the like.

The system integrates with third party exchange sites that allow users to exchange tickets or other products. Furthermore, the system integrates with seller systems and third party systems (such as product or ticket vendors) to verify that the seller owns the tickets or products, the system does this via identification that the seller purchased the products or tickets from a product vendor. In this way, the system creates a proof of ownership network. The system then generates a smart contract network with three parties, the proof of ownership network, the seller, and the buyer. The smart contract does not allow resources to be released from the buyers account until the smart contract has confirmation from the third party product vendor that the seller actually owns the product/tickets. The system, via the smart contract, then extracts the products/tickets from the seller and transfers the funds to the seller. The system using smart contracts, and not holding the assets, may move the asset without introducing an ability for misappropriation, creating an authentication escrow network. In some embodiments, the escrow network may also hold pending offers, so that users may see other offers the seller has for the product. The escrow network may hold or otherwise prevent the seller from using the product. The payment for the product may not be associated with the escrow network, as such allowing the buyer to use any payment means for completing the transaction.

This provides the buyer with a ticket and the system knows who the buyer is. Furthermore, using this information, the system could tailor the experience to that particular buyer as potential value adds (such as welcome gifts, drinks, food, or the like tailored to the particular buyer).

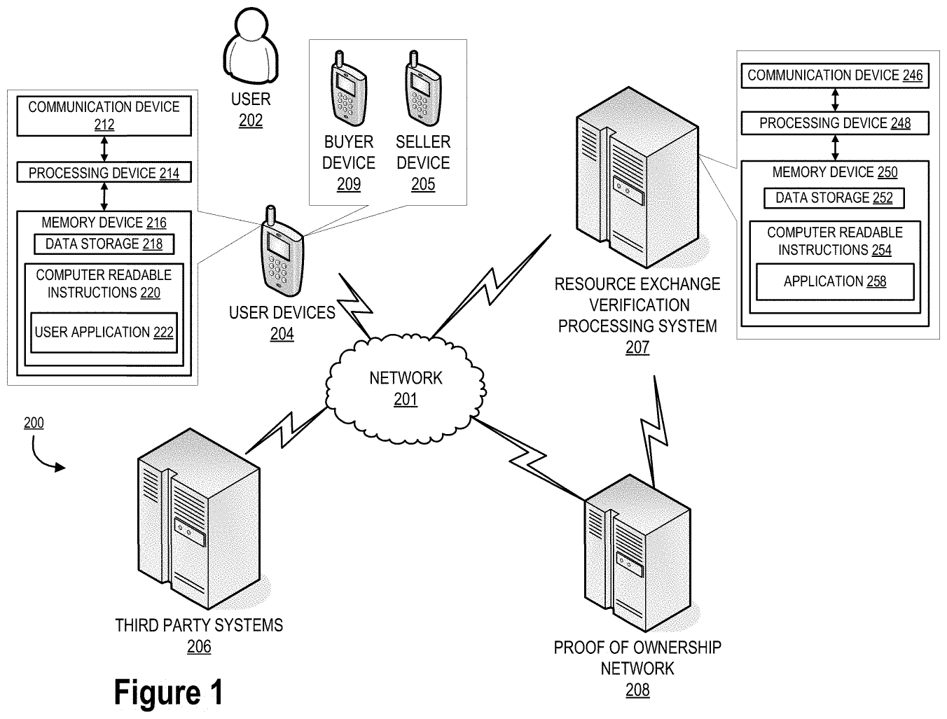

FIG. 1 illustrates a resource exchange verification processing system environment 200, in accordance with embodiments of the present invention. FIG. 1 provides the system environment 200 for which the distributive network system with specialized data feeds associated resource exchange verification processing. FIG. 1 provides a unique system that includes specialized servers and system communicably linked across a distributive network of nodes required to perform the functions of resource exchange verification processing.

As illustrated in FIG. 1, the proof of ownership system 208 is operatively coupled, via a network 201 to the user device 204, resource exchange verification processing system 207, and to the third party systems 206. In this way, the proof of ownership system 208 can send information to and receive information from the user device 204, resource exchange verification processing system 207, and the third party systems 206. The proof of ownership network 208 is in direct communication linkage with the resource exchange verification processing system 207 and the third party systems 206. The proof of ownership network 208 may link with the third party systems 206 to determine if an individual user 202 has ownership of a product he/she is wishing to distribute via a third party exchange site. In this way, the proof of ownership network 208 may work in conjunction with one or more third parties such as product vendors or the like in order to determine if a user 202 was an original owner of the product posted to the third party exchange site. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is one or more individuals selling or purchasing products on a third party exchange site. In some embodiments, the products may be tickets for a concert, play, sporting event, cinema, or the like. The user may have one or more accounts associated with resources for distribution such as checks, person-to-person payments, debit cards, credit cards, or the like. One or more of these accounts may be associated with a digital resource distribution network. FIG. 1 also illustrates a user device 204. The user device 204 may be the buyer device 209 or the seller device 205 depending on if the user 202 is a buyer or seller of products on the third party exchange site. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the third party systems 206, the proof of ownership system 208, and the resource exchange verification processing system 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to set up marker codes and communicate with the third party systems 206. The buyer device 209 and the seller device 205 may have the same or similar elements as the user device 204.The buyer device 209 and the seller device 205 may have the same or similar elements as the user device 204.

As further illustrated in FIG. 1, the resource exchange verification processing system 207 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the proof of ownership system 208, the third party systems 206, and the user device 204. As such, the communication device 246 generally comprises a modem, server, or other device for communicating with other devices on the network 201.

As further illustrated in FIG. 1, the resource exchange verification processing system 207 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the resource exchange verification processing system 207 the memory device 250 stores an application 258. Furthermore, the resource exchange verification processing system 207, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more proof of ownership system 208, resource exchange verification processing system 207, and/or user device 204.

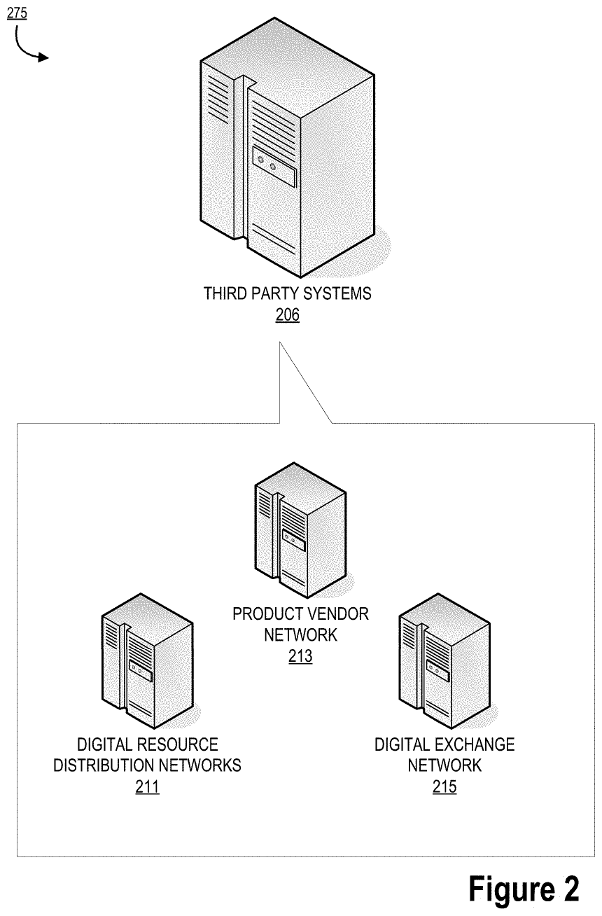

As illustrated in FIG. 1, the third party systems 206 is connected to the proof of ownership system 208, user device 204, and resource exchange verification processing system 207. The third party systems 206 has the same or similar components as described above with respect to the user device 204 and the resource exchange verification processing system 207. Third party systems 206 are further detailed below with respect to FIG. 2.

It is understood that the servers, systems, and devices described herein illustrate one embodiment of the invention. It is further understood that one or more of the servers, systems, and devices can be combined in other embodiments and still function in the same or similar way as the embodiments described herein. The proof of ownership system 208 may generally include a processing device communicably coupled to devices as a memory device, output devices, input devices, a network interface, a power source, one or more chips, and the like. The proof of ownership system 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like. The memory device may store any of a number of applications or programs which comprise computer-executable instructions/code executed by the processing device to implement the functions of the proof of ownership system 208 described herein.

FIG. 2 illustrates the third party systems communicably linked within the resource exchange verification processing system 275, in accordance with embodiments of the present invention. As illustrated, the third party systems 206 may include one or more of digital resource distribution networks 211, product vendor networks 213, and or digital exchange networks 215. Each of the one or more of digital resource distribution networks 211, product vendor networks 213, and or digital exchange networks 215 is connected to the proof of ownership system 208, user device 204, and resource exchange verification processing system 207. The one or more of digital resource distribution networks 211, product vendor networks 213, and or digital exchange networks 215 have the same or similar components as described above with respect to the user device 204 and the resource exchange verification processing system 207.

In some embodiments, the digital resource distribution networks 211 comprises a network for transferring resources via a P2P payment application in coordination with a digital wallet application on the user's mobile device. Here, for example, the system may send the payment to a credit card associated with the recipient. Consequently, the system may present the functionality of the P2P payment application and/or the digital wallet application within the interface of the enhanced resource sharing management application to facilitate completion of the payment transfer.

In some embodiments, the digital resource distribution networks 211 may provide a new payment vehicle to the user, for example, a credit card to the digital wallet of the user, in near real time to facilitate the payment transaction. For example, the digital resource distribution networks 211 may provide a new payment vehicle suitable for the geographic region that the user is travelling to, a vehicle that provides certain incentives/rebates and the like. In some embodiments, the system provides foreign exchange services to facilitate overseas payments. Moreover, the digital resource distribution network may analyze user information, e.g., user financial information and determine that the user may utilize existing gift cards, travel benefits, other accounts or incentives, to complete at least a portion of the payment for the dwelling reservations, and provide specific interfaces/overlays to facilitate the user of benefits, gift cards and the like.

In some embodiments, the product vendor networks 213 may be networks associated with one or more vendors or entities that initially distributing the product. In this way, a ticket for a sporting event may have been initially distributed by the sports team or event location. As such, the product vendor network 213 for that particular ticket would be the network associated with the sports team or event location. The product vendor or initial distributor of the product may be in communication with the resource exchange verification processing system 207 and/or the proof of ownership network 208 to identify if the buyer is the actual owner of the ticket.

The digital exchange networks 215 comprise one or more online platforms for buyers and sellers to post products for sale or for viewing products to purchase. These digital exchange networks 215 may allow individual users to post their own products for sale on the digital exchange networks 215. The digital exchange networks 215 may broadcast the product for sale across the network for other users or individuals to review. This broadcasting may be via the internet and the digital exchange networks 215 may charge a fee and/or collect a fee for the final purchase price.

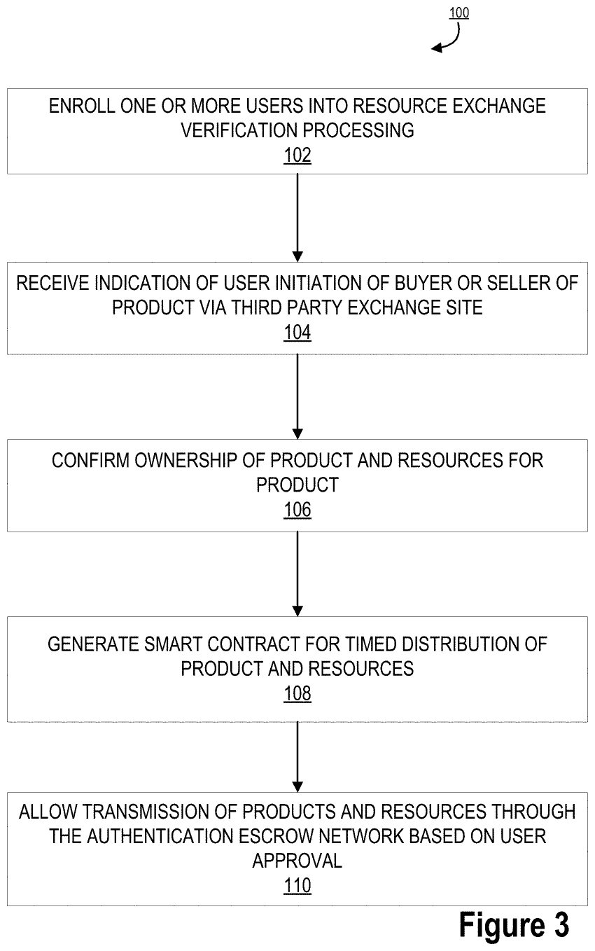

FIG. 3 illustrates a high level flowchart of the resource exchange verification process 100, in accordance with embodiments of the present invention.

The system integrates with third party exchange sites that allow users to exchange tickets or other products. Furthermore, the system integrates with seller systems and third party systems (such as product or ticket vendors) to verify that the seller owns the tickets or products, the system does this via identification that the seller purchased the products or tickets from a product vendor. In this way, the system creates a proof of ownership network. The system then generates a smart contract network with three parties, the proof of ownership network, the seller, and the buyer. The smart contract does not allow resources to be released from the buyers account until the smart contract has confirmation from the third party product vendor that the seller actually owns the product/tickets. The system, via the smart contract, then extracts the products/tickets from the seller and transfers the funds to the seller. The system using smart contracts, and not holding the assets, may move the asset without introducing an ability for misappropriation, creating an authentication escrow network. In some embodiments, the escrow network may also hold pending offers, so that users may see other offers the seller has for the product. The escrow network may hold or otherwise prevent the seller from using the product. The payment for the product may not be associated with the escrow network, as such allowing the buyer to use any payment means for completing the transaction.

This provides the buyer with a ticket and the system knows who the buyer is. Furthermore, using this information, the system could tailor the experience to that particular buyer as potential value adds (such as welcome gifts, drinks, food, or the like tailored to the particular buyer).

As illustrated in block 102, the process 100 is initiated by enrolling one or more users into the resource exchange verification processing system. In this way, the user may enroll in the resource exchange verification processing system by accessing one or more applications associated with the system and/or a third party confirming enrollment and authorization of the user for the processing system.

Next, as illustrated in block 104, the process 100 continues by receiving an indication that the enrolled user is initiating as a buyer or a seller of a product via a third party exchange site. In this way, a seller may post one or more products on a third party exchange site. The third party exchange site comprise one or more online platforms for buyers and sellers to post products for sale or for viewing products to purchase. The third party digital exchange site may allow individual users to post their own products for sale on the site. The site may broadcast the product for sale across the network for other users or individuals to review.

As illustrated in block 106, the process 100 continues by confirming ownership of the product by the seller and resources for the product by the buyer. In some embodiments, the system may confirm ownership of the product by the seller based on system communications with the product vendor. In some embodiments, the product vendor may be networks associated with one or more vendors or entities that initially distributing the product. For example, a ticket for a sporting event may have been initially distributed by the sports team or event location. As such, the product vendor for that particular ticket would be the network associated with the sports team or event location. The product vendor or initial distributor of the product may be in communication with the system to identify if the buyer is the original buyer of the product. In this way, the system may communicate with the product vendors to determine if the seller was one or more users who purchased the product from the product vendor. In some embodiments, the system may also determine if the seller purchased the product second hand from an alternative vendor. In this way, the system may check the seller product based on seller information to determine authenticity of the product or ticket.

In some embodiments, the system may confirm ownership of the resources for purchase of the products by the buyer. In this way, the system may interact with account management institutions, such as financial institutions, and digital resource distribution networks the buyer may use to identify that the user has resources available to purchase the product.

Next, as illustrated in block 108, the process 100 continues by generating a smart contract for timed distribution of products and resources. In this way, the system may generate a smart contract to trigger deployment of the products at the time of resource distribution. In this way, the system, via the smart contract may communicably link with the digital resource distribution network of the buyer and the digital third party exchange site the seller used to post the product in order to distribute the product and the resources in coordination as to not allow for misappropriation of the product upon deployment of the resources. In this way, the system prevents misappropriation by the seller by holding the product within an authentication escrow network to prevent the seller from receiving the resources for the buyer without distributing the product to the buyer. As such, the system holds the products, such as tickets, in an escrow account so that the seller cannot pull the products and disappear when he/she receives the resources, without distributing the products to the buyer.

Next, as illustrated in block 110, the process 100 is completed by allowing transmission of the products and resources through the authentication escrow network based on the user approvals for completion of the transaction. In this way, upon indication that both resources and products where posted to the authentication escrow network and the transaction is approved for completion by the users and the system based on the trigger of the products and resources being presented to the escrow network. In some embodiments, the escrow network may also hold pending offers, so that users may see other offers the seller has for the product. The escrow network may hold or otherwise prevent the seller from using the product. The payment for the product may not be associated with the escrow network, as such allowing the buyer to use any payment means for completing the transaction.

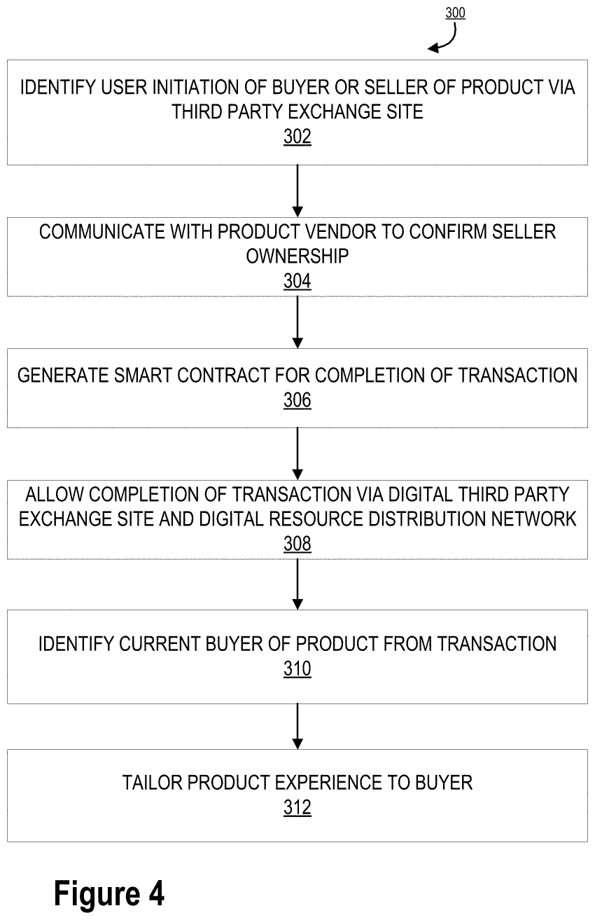

FIG. 4 illustrates a process for resource exchange verification and follow on experience tailoring 300, in accordance with embodiments of the present invention. As illustrated in block 302, the process 300 is initiated by identifying user initiation of a buyer or seller of a product via third party exchange site. In this way, a seller may post one or more products on a third party exchange site. The third party exchange site comprise one or more online platforms for buyers and sellers to post products for sale or for viewing products to purchase. The third party digital exchange site may allow individual users to post their own products for sale on the site. The site may broadcast the product for sale across the network for other users or individuals to review.

As illustrated in block 304, the process 300 continues by communicating with product vendors to confirm seller ownership of the product. In some embodiments, the system may confirm ownership of the product by the seller based on system communications with the product vendor. In some embodiments, the product vendor may be networks associated with one or more vendors or entities that initially distributing the product. For example, a ticket for a sporting event may have been initially distributed by the sports team or event location. As such, the product vendor for that particular ticket would be the network associated with the sports team or event location. The product vendor or initial distributor of the product may be in communication with the system to identify if the buyer is the original buyer of the product. In this way, the system may communicate with the product vendors to determine if the seller was one or more users who purchased the product from the product vendor. In some embodiments, the system may also determine if the seller purchased the product second hand from an alternative vendor. In this way, the system may check the seller product based on seller information to determine authenticity of the product or ticket.

In some embodiments, there may be multiple owners of the product before the seller. While in some embodiments, the system may identify that the seller owns the product via communication with the original product vendor, the original product vendor may not know that the seller owns the product after one or more later exchanges. In this way, the original product vendor may be able to verify the authenticity of the product even if it is not able to provide information that the seller is the original owner of the product. Furthermore, the system may not allow access to one or more previous owners of the product as to avoid the buyer going directly to a previous seller for future transaction.

Next, as illustrated in block 306, the process 300 continues by generating a smart contract for completion of the transaction. The smart contract is generated by the system specifically for the transaction. The smart contract includes an authentication escrow network to act as an escrow for holding of the products and resources for prevention of misappropriation by the seller by receiving the resources and not providing the product in exchange for the resources. As such, the product is placed in the authentication escrow network out of possession of the seller. Once the resources are distributed from the buyer to the seller via a digital resource distribution network, the authentication escrow network may release the product to the buyer. In this way, as illustrated in block 308, the process 300 continues by allowing completion of the transaction via the digital third party exchange site and the digital resource distribution network.

As illustrated in block 310, the process 300 continues by identifying the current buyer of the product from the transaction. In this way, the system may know the identity of the user that purchased the product. This is based on the user enrollment into the system and the processing of the transaction via the system.

Using the information, the system may be able to tailor products experiences to the buyer, as illustrated in block 312. In this way, the system may know the product and the buyer. The product may be a ticket to a sporting event. As such, the system may tailor an experience for the buyer around the sporting event. This may include potential value adds for the buyer, such as welcome gifts, drinks, food, or the like tailored to the particular buyer.

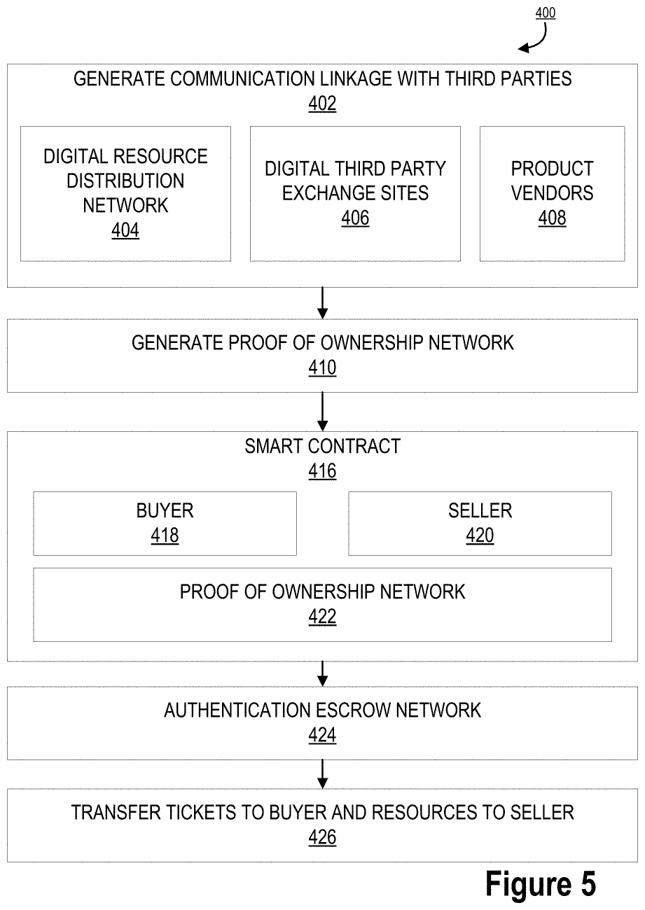

FIG. 5 illustrates generating communicable linkages and network for smart contract deployment within the resource exchange verification process 400, in accordance with embodiments of the present invention. As illustrated in block 402, the process is initiated by generating a communication linkage with third parties. These third parties may include one or more of digital resource distribution networks 404, digital third party exchange sites 406, and product vendors 408.

In some embodiments, digital resource distribution networks 404 comprise a network for transferring resources via a P2P payment application in coordination with a digital wallet application on the user's mobile device. Here, for example, the system may send the payment to a credit card associated with the recipient. Consequently, the system may present the functionality of the P2P payment application and/or the digital wallet application within the interface of the enhanced resource sharing management application to facilitate completion of the payment transfer.

In some embodiments, the digital resource distribution networks 404 may provide a new payment vehicle to the user, for example, a credit card to the digital wallet of the user, in near real time to facilitate the payment transaction. For example, the digital resource distribution networks 404 may provide a new payment vehicle suitable for the geographic region that the user is travelling to, a vehicle that provides certain incentives/rebates and the like. In some embodiments, the system provides foreign exchange services to facilitate overseas payments. Moreover, the digital resource distribution network may analyze user information, e.g., user financial information and determine that the user may utilize existing gift cards, travel benefits, other accounts or incentives, to complete at least a portion of the payment for the dwelling reservations, and provide specific interfaces/overlays to facilitate the user of benefits, gift cards and the like.

In some embodiments, digital third party exchange sites 406 comprises one or more online platforms for buyers and sellers to post products for sale or for viewing products to purchase. These digital third party exchange sites 406 may allow individual users to post their own products for sale on the digital third party exchange sites 406. The digital third party exchange sites 406 may broadcast the product for sale across the network for other users or individuals to review.

In some embodiments, product vendors 408 may be networks associated with one or more vendors or entities that initially distributing the product. In this way, a ticket for a sporting event may have been initially distributed by the sports team or event location. As such, the product vendors 408 for that particular ticket would be the network associated with the sports team or event location.

Next, as illustrated in block 410, the process 400 continues by generating a proof of ownership network. The proof of ownership network is in direct communication linkage with the third parties. The proof of ownership network may link with the third party systems to determine if an individual user has ownership of a product he/she is wishing to distribute via a third party exchange site. In this way, the proof of ownership network may work in conjunction with one or more third parties such as product vendors or the like in order to determine if a user was an original owner of the product posted to the third party exchange site.

As illustrated in block 416, once the transaction has been initiated and true ownership of the product has been identified to be with the seller, the system may generate a smart contract for the transaction on the digital third party exchange site with payment being provided via a digital resource distribution network. The smart contract may be triggered between the buyer 418, seller 420, and the generated proof of ownership network 422.

The system then triggers the product and/or resources be placed into the authentication escrow network, as illustrated in block 424. In this way, the system may hold the product in escrow so that no misappropriation may take place. Furthermore, the system may instigate the triggering of a hold of resources at the digital resource distribution network. Finally, as illustrated in block 426, the process 400 is completed by transferring the tickets or products to the buyer and transferring the resources to the seller.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for resource exchange verification processing, the system comprising:
a memory device with computer-readable program code stored thereon;
a communication device;
a printing device for printing the resource distribution documents;
a processing device operatively coupled to the memory device and the communication device, wherein the processing device is configured to execute the computer-readable program code to:
interconnect with a digital resource distribution network and a digital third party exchange site via generating a communication linkage;
identify a user initiation of an exchange via the digital third party exchange site;
communicate with a product vendor for a product of the exchange, wherein the product vendor is an original distributor of the product of the exchange;
generate a smart contract within a communicably linked proof of ownership network upon indication from the product vendor the user possesses the product of the exchange;
place the product of the exchange into an authentication escrow network and trigger distribution of resources via a digital resource distribution network; and
upon distribution of resources, trigger release of the product of the exchange.

2. The system of claim 1, further comprising identifying the user that is a new recipient of the product of the exchange and tailor an experience around an event associated with the exchange to the user including added products associated with the product of the exchange.

3. The system of claim 1, wherein the authentication escrow network is an escrow that holds the product of the exchange such that a seller of the product of the exchange does not have possession of the product of the exchange upon buyer distribution of resources via the digital resource distribution network.

4. The system of claim 1, wherein communicating with an original product vendor for a product of the exchange further comprises receiving indication from the product vendor confirming or denying user possession of the product of the exchange.

5. The system of claim 1, wherein the user is a buyer or seller of the product on the digital third party exchange site, wherein the user is enrolled in the resource exchange verification processing prior to initiation of an exchange.

6. The system of claim 1, wherein the exchange via initiated via the digital third party exchange site is an exchange for the product, wherein the product is a ticket to one or more events.

7. The system of claim 1, wherein the user is a buyer purchasing the product using the digital resource distribution network to transfer resources to a seller for the product of the exchange.

8. The system of claim 1, wherein the user is a seller selling the product using the digital third party exchange site to transfer the product of the exchange to a buyer for resources.

9. A computer program product for resource exchange verification processing with at least one non-transitory computer-readable medium having computer-readable program code portions embodied therein, the computer-readable program code portions comprising:
an executable portion configured for interconnecting with a digital resource distribution network and a digital third party exchange site via generating a communication linkage;
an executable portion configured for identifying a user initiation of an exchange via the digital third party exchange site;
an executable portion configured for communicating with a product vendor for a product of the exchange, wherein the product vendor is an original distributor of the product of the exchange;
an executable portion configured for generating a smart contract within a communicably linked proof of ownership network upon indication from the product vendor the user possesses the product of the exchange;
an executable portion configured for placing the product of the exchange into an authentication escrow network and trigger distribution of resources via a digital resource distribution network; and
an executable portion configured for upon distribution of resources, triggering release of the product of the exchange.

10. The computer program product of claim 9, further comprising an executable portion configured for identifying the user that is a new recipient of the product of the exchange and tailor an experience around an event associated with the exchange to the user including added products associated with the product of the exchange.

11. The computer program product of claim 9, wherein the authentication escrow network is an escrow that holds the product of the exchange such that a seller of the product of the exchange does not have possession of the product of the exchange upon buyer distribution of resources via the digital resource distribution network.

12. The computer program product of claim 9, wherein communicating with an original product vendor for a product of the exchange further comprises receiving indication from the product vendor confirming or denying user possession of the product of the exchange.

13. The computer program product of claim 9, wherein the user is a buyer or seller of the product on the digital third party exchange site, wherein the user is enrolled in the resource exchange verification processing prior to initiation of an exchange.

14. The computer program product of claim 9, wherein the exchange via initiated via the digital third party exchange site is an exchange for the product, wherein the product is a ticket to one or more events.

15. A computer-implemented method for resource exchange verification processing, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
interconnecting with a digital resource distribution network and a digital third party exchange site via generating a communication linkage;
identifying a user initiation of an exchange via the digital third party exchange site;
communicating with a product vendor for a product of the exchange, wherein the product vendor is an original distributor of the product of the exchange;
generating a smart contract within a communicably linked proof of ownership network upon indication from the product vendor the user possesses the product of the exchange;
placing the product of the exchange into an authentication escrow network and trigger distribution of resources via a digital resource distribution network; and
upon distribution of resources, triggering release of the product of the exchange.

16. The computer-implemented method of claim 15, further comprising identifying the user that is a new recipient of the product of the exchange and tailor an experience around an event associated with the exchange to the user including added products associated with the product of the exchange.

17. The computer-implemented method of claim 15, wherein the authentication escrow network is an escrow that holds the product of the exchange such that a seller of the product of the exchange does not have possession of the product of the exchange upon buyer distribution of resources via the digital resource distribution network.

18. The computer-implemented method of claim 15, wherein communicating with an original product vendor for a product of the exchange further comprises receiving indication from the product vendor confirming or denying user possession of the product of the exchange.

19. The computer-implemented method of claim 15, wherein the user is a buyer or seller of the product on the digital third party exchange site, wherein the user is enrolled in the resource exchange verification processing prior to initiation of an exchange.

20. The computer-implemented method of claim 15, wherein the exchange via initiated via the digital third party exchange site is an exchange for the product, wherein the product is a ticket to one or more events.
